(19) United States
(12) Patent Application Publication
(10) Pub. No.: US 2007/0170252 A1
(43) Pub. Date: Jul. 26, 2007

(54) Voting Machine with Secure Memory Processing

(76) Inventor: Kevin R. Orton, Santa Ana, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/626,821

(22) Filed: Jan. 24, 2007

Related U.S. Application Data
(60) Provisional application No. 60/762,192, filed on Jan. 24, 2006.
(60) Provisional application No. 60/762,357, filed on Jan. 26, 2006.

(51) Int. Cl. G07C 13/00

(52) U.S. Cl. 235/386

(57) ABSTRACT

An integrated voting system includes a memory element configured with multiple lock bits. Lock bits are arranged according to vote records, thereby allowing each individual vote cast to be recorded securely, providing a tamper-resistant record of the vote count. The system forms a complete, integrated, secure voting system that can be re-used on different elections without requiring any updates, changes, or other maintenance.

### CROSS-REFERENCE TO RELATED APPLICATIONS

This application claims priority to and incorporates by reference U.S. provisional patent application Ser. No. 60/762,192, filed Jan. 24, 2006, and U.S. provisional patent application Ser. No. 60/762,357, filed Jan. 26, 2006.

### BACKGROUND OF THE INVENTION

Voting machines are an important requirement for a democratic society. They help provide accurate and efficient voting. Many voting machines are purely mechanical in operation, and as such are a bit archaic for modern standards. They also are subject to mechanical and user errors that can give inaccurate results, which is undesirable.

Other more modern systems are electronic. They often feature display screens, custom software, and many user controls. These systems can be quite complex. These systems are software controlled. However, even modern software tends to be error prone. Software also does not resist tampering very well, making the use of complex security and encryption algorithms necessary. Even then, the software protection techniques are not always effective. They also require elaborate certification procedures before the software can be approved for public use. And every time the software is changed, which is pretty much before every election, the software must be re-certified. Neither is the certification process error free, as software can be written with “back doors”, which can not be found in normal testing. This can lead to improper vote counts. It can be difficult to detect or verify if tampering has taken place. Further, if tampering does take place, it can be difficult to track down and tabulate what the correct voter count actually is.

There are also problems with securely installing updated software in the voting machines themselves in a secure, traceable manner that prevents tampering. With the complex nature of these systems, they are expensive to purchase and maintain, and require skilled professionals to do so, which can reduce user confidence. They are also difficult to verify the voting record, unless the whole voting machine hardware and software installation is verified also, which is difficult to do, and relies upon proprietary vendors. Thus a modern, accurate dependable machine that is also simple, reliable, and highly verifiable is desired. This invention provides such a means.

In one aspect of the invention, a novel computing chip with an internal processor is used. The internal processor is generally of a fixed function, and does not require or use software updates. The internal processor is preferably formed as circuits on the silicon at the same time as the memory elements are formed, in one unified device. The internal processor may be a microprocessor, or other architecture logic device.

In another aspect of the invention, a memory chip is provided. The memory chip works with the processing circuitry to provide novel functions for performing voting procedures and storing the vote tabulations in a manner that are secure, and may be recalled later. The memory chip includes novel security features that make the secure memory chip particularly well suited to tabulate votes.

### BRIEF DESCRIPTION OF THE DRAWINGS

FIG. 1 is a table showing one possible memory configuration arrangement of the voting chip.

FIG. 2 is a drawing of the voting chip configured into a voting card (A) and as a voting card with a label (B).

FIG. 3 is a drawing showing how the memory chip may be used and integrated with peripheral devices to form a complete, secure voting system.

FIG. 4 is a diagram illustrating certain methods of using the memory chips and voting systems described herein.

FIG. 5 is a drawing that shows how the voting chip may be physically implemented.

### DETAILED DESCRIPTION OF THE INVENTION

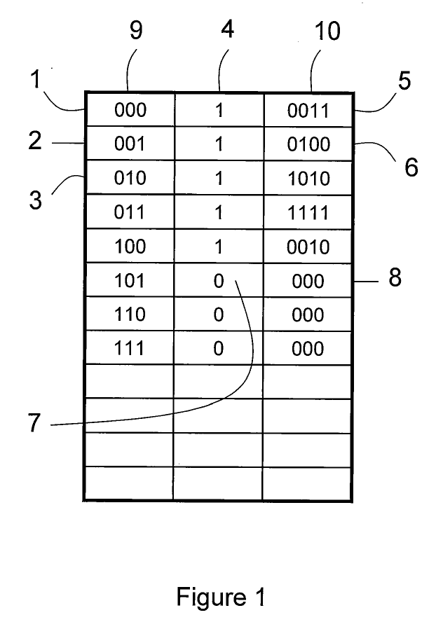

FIG. 1 shows how the voting memory is laid out in one preferred embodiment. FIG. 1 depicts the memory laid out in a row-column format. Column (9) depicts the address for each memory location. The address may be sequentially numbered in binary format, and are generally selected by a memory counter that is part of the circuitry of the chip. In rows 1, 2, and 3, (1) (2) (3), the memory counter address starts at zero and increases from there.

Column (4) contains a write-protect bit. This bit is blank initially. Column (10) contains vote data. Column (10) is typically much wider than shown, and contains vote data for all initiatives of one ballot to be cast. It may also contain check sum information or other information to help insure proper tabulation.

When a new ballot is to be cast, the memory counter selects the next available incremental address within the memory array. For example, if this is the second ballot to be cast since the chip was initialized, the memory counter may move to row 2 (2). When the cast ballot button is pressed, the vote data may be recorded in column (10) row (2). Once the vote data is recorded, a lock bit column (4) row (2) is set. The lock bit locks the data in column (10) row (2) from any further writing or modification. It also indicates that a valid voting session has taken place in that memory location.

If an attempt were somehow to be made to write to a previously used memory location, the record lock would prevent such action.

As each voting session ends, and the vote selections are cast, the data is written to the memory location and saved. The memory counter is then incremented by 1 for the next available voting session.

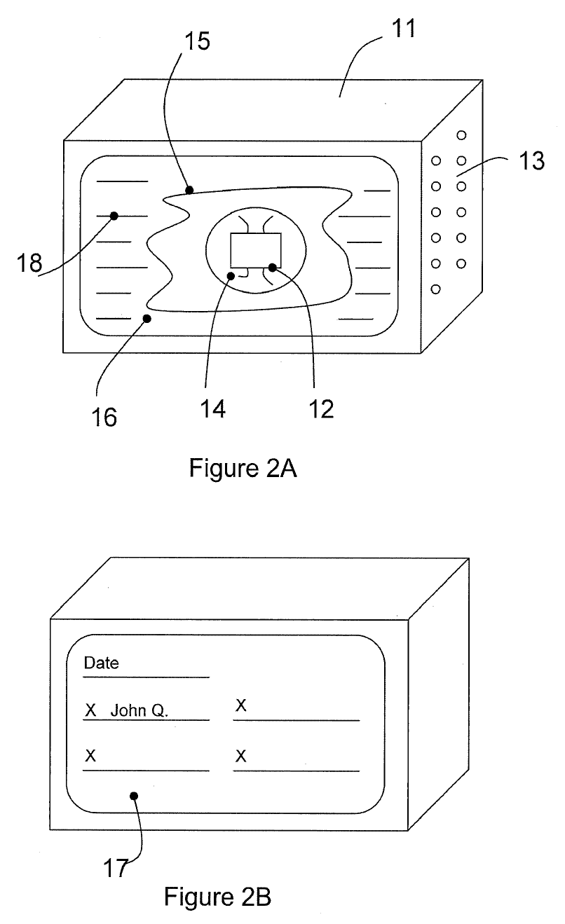

Referring to FIG. 2A, in one preferred embodiment, a housing (11) contains the voting microchip (12) which performs the logic and/or memory functions of the chip. A connector (13) allows signals and power to enter and exit the chip. A window (14) along with an opening (15) in the first label (16) allows the silicon chip (12) to be viewed from the outside in a non-destructive manner.

Since the silicon chip can be viewed without being damaged, it can be verified as being an authentic authorized voting chip, either before using the voting chip, or after. This is useful if there is for example a dispute about the authenticity of the voting chip after the election is over and the votes have been counted. Microscopes and high-resolution photographic techniques can verify the pattern of the silicon against the known approved silicon pattern to detect an unauthorized voting chip, without damaging the voting chip. If this were to happen, for example, it would be required and necessary to run the election again, that time using an authorized voting chip. However, the fraudulent action could be detected. Thus the voting chip provides a secure record of the vote for later examination.

On one portion of the voting chip, a second label (17) may be provided. This label may be written on with a writing instrument. The label may be used as a place where election officials may sign the voting chip before placing it in service. The label and signing help prevent tampering if for example the voting chip were to get swapped with another one between the time it is placed in service, and the time it is removed from service. The election official's signature(s) would help to verify that the correct voting chip has been collected.

On the other side of the card, a serial number and/or holographic image (18) or other such identifier may be placed on the card surface to aid tracking and identification of the card, and to discourage tampering or counterfeiting.

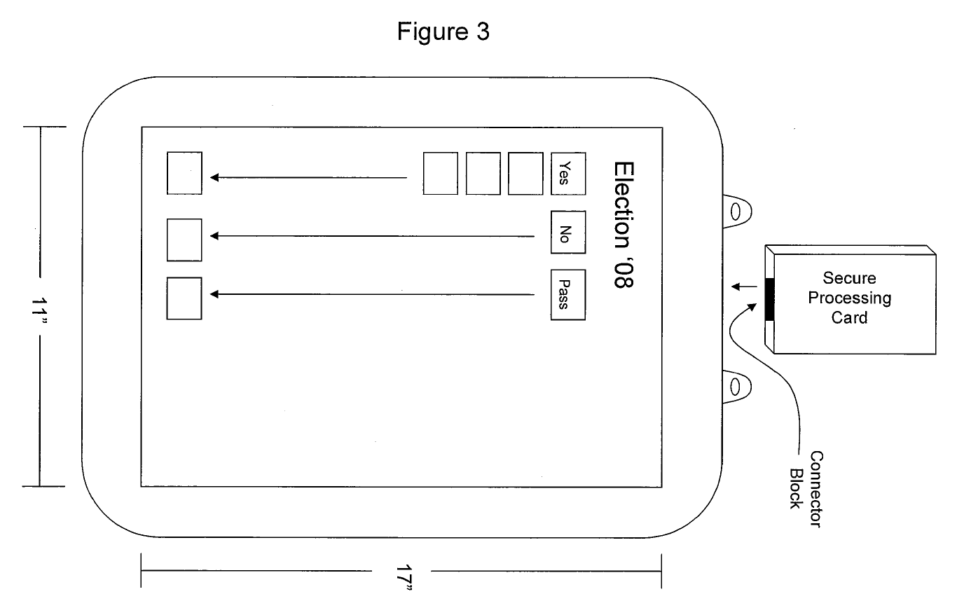

Referring to FIG. 3, in one embodiment the voting chip fits into a housing unit. The housing unit has user-interface buttons and support. The housing unit may be a “dumb” hardware, in that it does not require any software or processing capability. Nor does it require software updates. The only updates are to a printed panel which provides the current voting session ballot list.

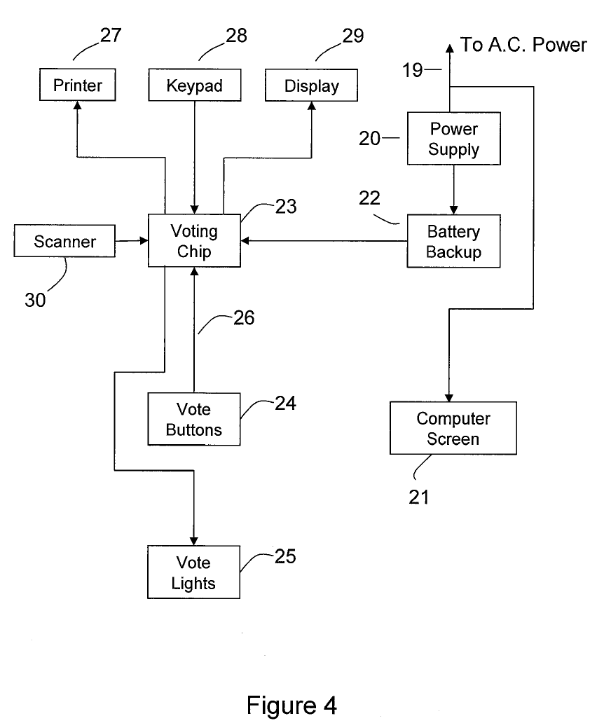

FIG. 4 is a block diagram of how various components may be configured in one preferred embodiment. There is a power source (19) which is typically a 110 volt wall outlet. The power source (19) goes to a power supply (20), and a computing device with screen (21). The computing device with screen contains menu programs to help guide the voter through the voting process.

The power supply (20) may include a battery backup (22), which powers the voting chip device (23), even if the 110 volt power should fail briefly. Connected to the voting chip, generally through a connector, are the voting buttons, (24) and vote indicator lights (25). The arrows (26) generally show the direction of data or power flow. The voting chip (23) may be and preferably is completely independent of the computing system and screen (21), with no shared data or software. The voting chip (23) may use a separate power supply of its own, so that no wires interconnect the voting chip and the computer screen (21).

Further referring to FIG. 4, (27) is an optional printer, (28) is an optional keypad, and (29) is an optional display and (30) a scanner. These components may be included to extend and enhance the capabilities of the voting chip.

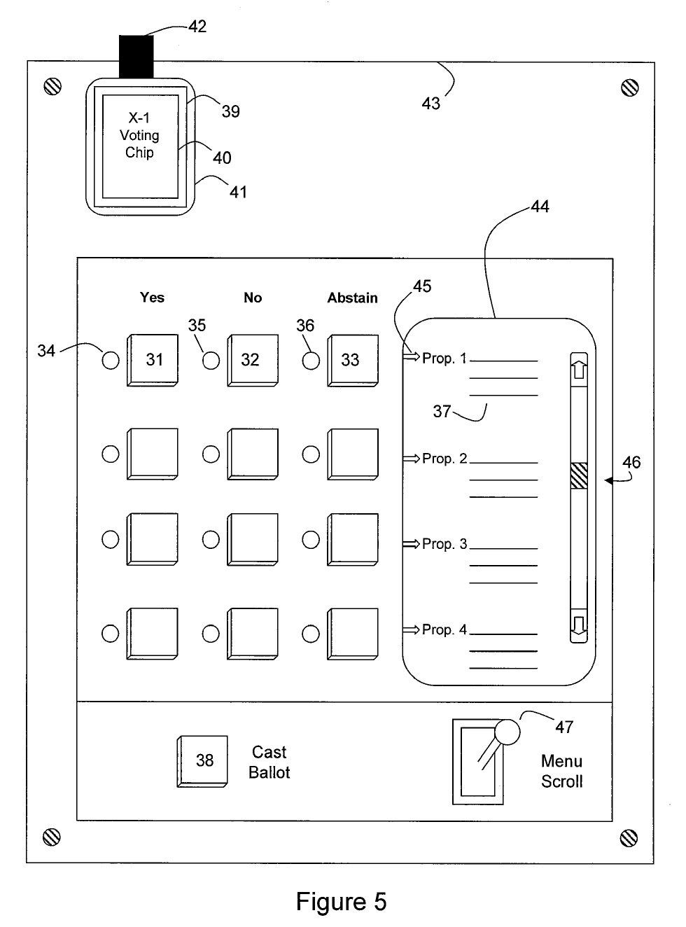

For example, the display may be a small alpha-numeric LCD display. This is used for example to guide the user in setting up the voting chip before actual voting begins. It may guide the user to select, for example, how many initiatives are on the ballot. When that data is selected, it may be input via the keypad (28). That will tell the voting machine how many of the rows of lights and buttons to use, if for example, there are more rows of lights and buttons [FIG. 5, (31)-(33) and (34)-(36)] than there are ballot initiatives, FIG. 5, (37), then some of the rows may be disabled. Once the voting chip is configured, it may generally not be changed once voting begins. The configuration process may take place at the place of voting. The configuration capability allows one voting chip design to be used in several different ways, for convenience. This means one voting chip design can be used for several different type and size of elections.

Returning to FIG. 4, the keypad may be used to enter configuration data. It may also be used to help the voting process. When the voting process is underway, it is desirable to prevent a single voter from casting multiple ballots. The voting machine may be used to accomplish this. In one such embodiment, when a voter presses the cast ballot button [FIG. 5, (38)], it signals to the voting machine that the current voter has finished. The voting machine may then be configured so as to not accept another ballot until certain conditions are met. For example when the voting machine may clear the light display and disable the cast ballot button and then generate an access code. The access code may be a random number that is generated, and a copy of which is saved, all inside the voting machine. The voting machine may display the access code on a small terminal display on the voter registration sign-in table, or make a printout of it. Only after a voter has been properly signed in, will the voter then be given the access code. The voter uses the access code to allow a new voting session on the voting machine. The voter does this by either writing down the access code at the sign-in table, or receiving a printout of the access code. The voter then takes the access code to the voting machine, and enters it on the keypad, or has it scanned in by the scanner (30). If the machine recognizes the code entered on the keypad, a new voting session is allowed, and the process repeats. Each time a new access code is generated, it is new and distinct from previous codes, to prevent re-use. Thus the voting machine is able to prevent secretive double balloting.

The printer, scanner, display, keypad and other peripheral devices may be powered from the voting machine, or separate power supplies. They may use a pre-set, hard-coded digital interface with the voting chip for security of the system.

FIG. 5 is a typical layout of the voting machine in one preferred embodiment. In the back of the machine is a socket (39) where a voting chip (40) may be placed. There is a secure strong housing (41) around the socket (39) and voting chip (40). The housing is preferably sized to fit the voting chip with little excess room. A locking device (42) may secure the voting chip (40) in position in the housing (41). The locking device may be of such a design that several keys are required to remove the voting chip from the housing, so that all handling of the voting chip is observed.

In the front of the machine is a panel assembly (43). The panel assembly has voting buttons (31), (32), (33), lights (34), (35), and (36), and a cast ballot button (38). The menus (37) on the display screen (44) provide directions and assistance to the voter, as well as ballot details. Arrows (45) or other indictors are positioned on the display (44) to line up with the voting buttons (31), (32), and (33). The menus (37) may be scrolled up and down using various controls, (46) and/or (47).

The internal processor acts as a conduit for data transfer into and out of the memory elements of the device.

The memory elements of the device are generally organized into blocks. Each block contains one or more bits of data. Each block has an address that allows selection of that block.

The internal processor is configured to allow external data to be read or written to each memory block, subject to certain limitations.

In one novel aspect, the internal processor allows data to be written to each memory block just one time. After the data is written, that memory block is marked with a record lock as having been used. At that point, that memory block may not be used again. It may however be read. The record lock mark function may be accomplished by setting a bit associated with the memory block, that that memory block or address has been written.

Each time before data is written to a block or address, the internal processor checks if that address has been written before. If a mark is found the write attempt for that memory block is aborted, and no data is saved. Thus the original and first data is preserved. The internal processor may also send a signal to an external device that such an error has occurred.

When all memory blocks are written, the device is used up, and no more data may be saved. The saved data, however, may still be read.

Applications for the device include such things as voting machines. For example, when using in a voting machine, the voting machine may be a computer device. The computer device may be loaded with application software that includes an electronic form of the ballot.

When the voter makes a selection, the choice is written to a memory location of the memory device. The internal processing circuitry of the memory device then marks that address location as being used. Once the address location is used, the internal processing circuitry of the memory device allows the contents of that location to be read, but not to be altered or written again.

The internal processor of the memory device prevents all changes to memory locations once they have been used.

A memory location is used when data is written to it. In contrast with the existing art, the data written may be ones or zeros, and the internal processor will protect the data from further changes whether it is a zero or a one or a combination or zeros and ones.

While the internal security processor is described as a processor, it may also be constructed of much simpler known circuitry, such as logic gates, as required to perform its function.

The device contains a plurality of memory locations. In use with a voting machine, generally each memory location serves to store the data from one voter. For example, in one embodiment, the voter makes their selections from the display menu of the voting machine. When complete, the vote data is sent to the memory device, in one batch of data along with the vote data, a time stamp or identification or other data may be stored along with the voting record. Such other data serves to provide an audit trail, should it be necessary or desirable to confirm the vote totals in greater detail. The voter data is saved to a memory block of the device, and the internal processor of the device then write protects that memory block. With modern chips, thousands of memory blocks, each holding data for one voter, may be fabricated on one silicon chip.

The internal processor may also hold data that acts like a program counter, which serves as a record of which memory blocks have been used, and which are available to write, so that the next open memory block may be quickly identified.

Alternately, when it is desirable to write a block of data to memory the memory device may be scanned through the range of available addresses until an un-used memory block is located.

The act of write protecting one block of memory in the device does not affect other blocks of memory in the device, which may still be used or write protected independently of each other.

One problem that occurs with existing memory devices is that blocks of memory may be written in at different times. This can cause a problem in voting machine applications if, for example, after the voting is complete, someone were to use a device to record additional un-authorized votes to the memory chip.

After the voting is complete, in order to verify the memory chip card is the original authorized card, the memory chip card may then be re-inserted into the initialization machine. Each of the election officials then re-enter their secret pin code data. (The pin code data of each election official is not known to the others.) The internal processor takes the secret pin code data from the election officials and compares it with the original pin code data held securely in the memory chip. If they match, the identity of the voting memory card is confirmed, and the vote data is read out for tabulation.

To overcome this problem an additional novel aspect is used. In one aspect of the invention, the memory chip contains a session locking mechanism. The session locking mechanism is preferably a circuit configuration that prevents any further data to be written to the chip after a certain event. The certain event is preferably arranged to resist tampering, and preferably does not rely on external functions. To accomplish this, the chip uses a novel circuit configuration in one preferred embodiment consisting of a lock data bit that signals the internal processor to not record any more memory blocks at all. The lock data bit is preferably automatically set by the internal processor when an end of session signal is received. The end of session signal is a signal to the internal processor that the voting session has ended, and no further votes should be recorded. The end of session signal should be highly secure, should occur seamlessly, and should be reliably performed. To accomplish this, in one aspect of the invention, an end of session signal is automatically generated when electrical power is removed from the chip. The removal of electrical power automatically initiates the end of session routine and sets the lock chip data bit. Setting the lock chip data bit requires only about 10 milliseconds of time. A very small capacitor may be used on the chip, or in the same package as the chip, to store enough power to perform the lock data function after power is removed.

At that point, when power is re-applied to the chip, the lock data bit will be set, and the internal processor will prevent any further data block writes to the chip. The existing data blocks may still be read, however, so that the total votes placed may be tabulated.

One problem that may occur is that memory chip cards may be swapped between the time voting is started, and the time voting is finished, in an unauthorized manner. The swapped card may contain unauthorized voting data.

In order to prevent swapping chip cards, a security process is preferably used. In one embodiment, the memory card is initiated before use. To initiate a memory card, a certain initiation procedure may be used. In one such procedure, an initiation machine is used to write initiation data to the chip. The memory chip card is inserted into the machine. Several election officials then each enter a secret pin code into the machine. The initiation machine records these secret pin codes into the memory chip. Once they are recorded in the chip, the internal processor can access the secret pin data, but the secret pin code data may not be read out of the chip directly.

The internal processor may contain countermeasure features to prevent phishing type of attacks that might be used to decipher the secret pin data. Such countermeasure features might include delay circuits and access limit counters that prevent excessive attempts to access the secret pin portion of the chip.

The internal processor may contain circuits to allow the memory chip data to be confirmed if for example only 5 out of 6 election official's secret pin code data matches, instead of 6 out of 6, in case of human error.

The voting machine that the voting memory chip card is used with need not be complex. In fact, it may consist of little more than some push button switches, and some LED lights.

The push button switches and the LED lights may all be under the control of the internal processor. For example, switches may be placed in a row (FIG. 1). There may be three switches for each ballot initiative.

The voting memory chips are disposable, and may be discarded after use, or saved for archiving.

In one novel aspect of the invention, a random number generator is used. The random number generator may be built into the chip, and may be quite a simple known design. The novel random number generator configuration is used to stagger the memory counter, so that the memory counter does not always move in sequential manner. For example, the memory counter may be configured to skip ahead to a random memory address determined by the random number generator. After the memory counter skips ahead to the specified address, it checks to see if that address has been used before. If that address has not been used, it uses that address to record the voting data. If that address has been used already, the memory counter may then begin incrementing sequentially until an un-used address is located. It then uses that address to record the voting data. If it reaches the end of the memory address range, it rolls over and starts back at the beginning. In this way, the votes are not recorded on the chip in any known order, so there is no way to determine which vote corresponds to which voter, even if the sequence of voters to use the voting machine is known.

The random number generator may be implemented for example as a free running counter that rolls over continuously, and which is stopped when the cast ballot button is pressed. Because the internal oscillator of the chip and the time that cast ballot button occurs will have no phase correlation, the corresponding random number will be highly random.

Randomly move ahead 2 address locations, instead of one address location, when a new voting session is started. If this occurs, a bit may also be set to tell the program counter to skip back one memory location on the next voting session.

For example, one could store switch choices in a buffer, ready to record the choices. The internal processor may also for example light up LED or other lights that are colored green, red, or amber, to indicate the choices of the voter from the contents of the buffer. When the voter has all the push buttons pressed that they desire, they press the cast ballot button. The memory chip then records the ballots as chosen to a memory block. The lights provide a feedback mechanism to insure that the memory chip is receiving the correct choices from the voter, and that no tampering or equipment failures are occurring. When the user presses the cast ballot button, the lights go out to confirm the ballot was cast.

Paper cards, computer screens, or printed media next to each set of push buttons describe each ballot initiative. The circuitry for such a voting machine can be very simple, with only mechanical switches and LED lights outside the memory card, and so can be easy to detect tampering by most any person.

The voting machine may display enough lights and buttons for all ballot initiatives at once. This allows the voter an easier time, as they can easily review their votes and make changes as desired. When they are finished, they press the cast ballot button.

The cast ballot button may include a mechanical cover over the button. The mechanical cover reduces the chance of accidentally pressing the cast ballot button prematurely. To press the button, the voter raises the cover, which may be spring loaded, and then presses the button.

The back surface of the voting card may contain an ink-writeable surface (FIG. 2B). This surface may be formed of a tamper resistant material, such as an applied rubberized paint or safety paper or the like. The writing surface provides an area where tracking information may be recorded. It may for example be used to keep track of all the voting cards in use that day. Data such as the date, card number x of x, and spaces for election officials to sign the card may be provided. In one scenario, when a card is to be used, the date and location may be written on the card in ink. Then each of several election officials sign the card. The card is then loaded into the voting machine socket, and a mechanical key lock or other physical device is used to secure the card in the voting machine. The card may then be initialized for use, and each election official may enter a private code. When the voting is finished, the card may be sent to a vote-tabulating machine. The vote-tabulating machine may be part of the voting machine, or it may be a separate device. Each election official may review and confirm their signature and/or private code to help prevent fraud or tampering that could occur by swapping a card. The machine displays the data, and the results are then declared official. The voting card may be saved in the event of later disputes.

The count tabulating machine is a simple device that may be used to display the voting record saved on the chip. The count tabulating machine may be a part of the voting machine, or a separate device. It generally includes a display or printout device, which is under the control of the voting card.

For example, the count tabulating machine may be a part of the voting machine. It may have an LCD display which is controlled by the voting chip circuitry.

When the voting is over, a command may be issued to end the voting. Each election official then enters their private code to confirm the end of voting. If the officials all enter their codes, the voting chip locks and does not take any more votes. It will then also display the total votes cast without further restriction. The chip may be configured to for example only require 3 out of 4 election officials to enter their codes to complete the process, in the case of possible external problems. Because the count tabulation display is under the control of the voting chip circuitry, there is little chance or opportunity for fraudulent use.

The voting cards are preferably manufactured under open regulation and supervision and inspection to insure they are made to the proper specifications. Because the cards are generic, they may be manufactured in advance, and held for use until needed.

The system provides a high level of security in that once the microelectronic circuit design of the voting chip memory card is approved and certified for use as a voting machine, they are difficult to “hack”, and any hacking attempt would either damage the card, or require more than the 8-10 hours that a typical voting session lasts. And once the computational circuitry of the system is certified for use, the voting chip design may be re-used on future elections, without requiring any re-certification. That is possible because all the computational circuitry required to perform and store the vote count is in the secure pre-certified module. External buttons and lights and devices can all be operated from the module and its certified design, without any external processing capability, to insure the highest level of security and tamper resistance.

The cards may contain features such a see-through window [FIG. 2—top panel (14)] that allow observation of the physical chip structure inside the chip from outside the card.

The window allows any user of a voting card to compare under a microscope the chip features of their chip with a chip or plot of a chip that is known to be good. The comparison can be made without losing or destroying the data on the chip, thus allowing further testing if counterfeiting is suspected. Windows with coloring agents or ultraviolet blocking glass can provide additional protection against tampering and data loss.

One advantage of the current invention over contemporary electronic voting systems is that it provides a secure record of the vote results. The record lasts after the voting is finished, and can easily be verified.

Another advantage is that no secret keys or pass codes or encryption techniques need to be used by the provider of the voting chip for secure and accurate results. This makes confirming the integrity of the vote much easier.

For example, the circuit diagrams, photo mask works, silicon etching patterns and all data associated with the voting chip may be freely distributed for peer review, with no loss of security. Once the original silicon design is reviewed and approved, there no is need for continual review with each new election, as the voting chip functions in its preferred embodiment as a generic universal vote tabulation device which can be used for different elections without requiring any changes to the design. It is only necessary to ensure authentic voting chips are used in any election, which is a much easier task than updating other voting systems with new software.

Because all the processing of the voting system (in the preferred embodiment) is done in the secure voting card, only simple “dumb” interface terminals are required for use of the system. This makes the system much more economical, reliable, and secure. And with much reduced maintenance cost and time.

If desired, the memory chips may contain internal and/or external serial numbers. The internal serial number, and the external serial number may or may not match. This may be used to help tracking of the voting chip, and to help confirm to the manufacturer of the chip if the chip is authentic. For example, there may be an internal electronic serial number placed in the chip by the manufacturer of the chip at the time of manufacture. The internal serial number may be random or sequential. It may not be possible to read the internal serial number from outside the chip, though it may be possible to confirm the internal serial number matches a certain value. This can be used as a counterfeiting protection measure.

For example, the manufacturer of the chip may record the internal serial number in a separate database when the internal serial number is programmed into the chip. The internal serial number is associated with the external serial number in the database. The manufacturer may then verify the chip by initiating a command inside the chip that causes the chip to get the serial number from the database outside the chip, and compare it to the serial number inside the chip, to see if it matches. If it does, the chip is confirmed as authentic.

Eproms are electronic chips, often formed of silicon, that are used to store digital data. There are a few other mechanisms available to store data, such as charge based devices, fuse based devices, bubble memory, any of which, and including other possibilities and emerging techniques for data storage, are all suitable for use as memory elements in the practice of this invention.

The exact physical configuration of the voting chip can take various forms, such as a micro chip (FIG. 2-3) or a packaged microchip (FIG. 1-2) or a combination of several micro-chips and other various forms without departing from the spirit and scope of the invention.

I claim:

1. A device for use in a voting system for secure tabulation of votes from at least one voting session comprising:
a voting card comprising:
a housing
a voting microchip comprising
a computing chip with an internal processor to perform voting procedures, and a memory element to store and recall vote tabulations,
a connector to external input and output devices for access to signals and for power supply, and
wherein the microchip has a security feature of being configured with a write-protect bit for each vote cast in the voting session.

2. The device of claim 1 further comprising a label on the device, wherein the label allows authorization.

3. The device of claim 1 further comprising a serial number or image on the device for identification.

4. The device of claim 1 further comprising a memory counter which may be incrementally set to a next voting session.

5. The device of claim 4 wherein the memory counter is set with a random number generator.

6. The device of claim 1 further comprising a window in the housing for viewing of the voting microchip.

7. The device of claim 6 wherein a silicon pattern of the voting microchip is accessible through the window to allow comparison with a known authenticated pattern of silicon to confirm verification.

8. The device of claim 1 wherein the housing is mechanically tamper proofed.

9. The device of claim 1 wherein the internal processor is a fixed function processor that coordinates with the memory element.

10. The device of claim 1 wherein the internal processor has an integrated hardwired computational circuit that interfaces to the external input and output devices.

11. The device of claim 1 wherein the processor allows data to be written to each memory block only one time.

12. The device of claim 1 wherein the external devices are selected from the group consisting of power source, power supply, computing device with screen, battery backup to power supply, printer, keypad, display screen and scanner.

13. A system for secure tabulation of votes comprising a device comprising:
a power supply,
a display housing to display a voter ballot and vote options comprising
a ballot choice menu, and
voter interface buttons,
a voter card comprising
a housing,
a voter microchip comprising
a computer chip with an internal processor to perform voting procedures,
a memory element to store and recall vote tabulations,
a plurality of connectors to external input and output devices.

14. A system as in claim 13 wherein the voting card portion operates independently of the ballot choice menu means.

15. A system as in claim 13 wherein the voting microchip has a security feature of being configured with a write-protect bit in the memory element for each vote cast in the ballot casting session.

16. A voting system as in claim 13 wherein the voting card portion of the system is designed to be disposable after use for one election session.

17. The system of claim 13 further comprising a label on the device, wherein the label allows authorization.

18. The system of claim 13 further comprising a number or image on the device for identification.

19. The system of claim 13 further comprising a window in the device for viewing the voting microchip.
